(19) United States
(12) Patent Application Publication
(10) Pub. No.: US 2007/0202934 A1
(43) Pub. Date: Aug. 30, 2007

(54) Mobile communication device having removable headset

(75) Inventor: Young S. Kim, Los Altos, CA (US)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/651,887

(22) Filed: Jan. 10, 2007

Related U.S. Application Data
(60) Provisional application No. 60/758,036, filed on Jan. 10, 2006.

(30) Foreign Application Priority Data
Jul. 12, 2006 (KR) 2006-65380

(51) Int. Cl. H04M 1/00

(52) U.S. Cl. 455/575.3

(57) ABSTRACT

Provided is a mobile communication device having a removable headset. The removable headset is mounted in a housing of the mobile communication device, and performs wireless communication with the housing when removed from the housing and provides a receiving unit when mounted in the housing. The headset is easy to carry because of being mounted in the mobile communication device and an embedded battery of the headset can be charged when the headset is mounted in the housing, thereby eliminating a need to carry a separate charger for the battery of the headset.

### PRIORITY

This application claims priority under 35 U.S.C. § 119 to an provisional patent application entitled “Mobile Communication Device Having Removable Headset” filed in the United States Patent & Trademark Office on Jan. 10, 2006 and assigned Ser. No. 60/758,036 and under 35 U.S.C. § 119 to an application entitled “Mobile Communication Device Having Removable Headset” filed in the Korean Intellectual Property Office on Jul. 12, 2006 and assigned Serial No. 2006-65380, the contents of each of which are incorporated herein by reference.

### BACKGROUND OF THE INVENTION

1. Field of the Invention

The present invention generally relates to a mobile communication device such as a Personal Digital Assistant (PDA), a cellular phone, and a Personal Communication Service (PCS) terminal, and in particular, to a headset provided in a mobile communication device.

2. Description of the Related Art

Generally, a mobile communication device refers to a device that can be carried with a user in order to use voice communication with their partners or to use contents provided by service providers via a base station. The mobile communication device also allows the users to enjoy voice communication or the wireless Internet by performing wired or wireless transmission/reception with the base station.

A service provided using a mobile communication device has been limited to voice communication or short message transmission in its early stage, but is now being expanded to a financial service like retail payment and a security service through home networking. In particular, recent years have seen steady progress in multimedia services such as downloading, reproduction or streaming of audio and video files.

With the multimedia service of the mobile communication device, the performance of the mobile communication device, for example data processing speed, has been continuously improved and a mobile communication technique for transmitting voluminous data files like moving picture files at high speeds has been developed.

In order to enjoy the multimedia service to the fullest, a display device and a sound output device are required. The display device has evolved from a black/white Liquid Crystal Display (LCD) to a color LCD or a Thin Film Transistor (TFT) to provide clear display.

Monophonic ring tones have evolved to implement 40-tone, 64-tone, and 128-tone melodies. Moreover, the user can enjoy a multimedia function with music files output from a sound output device of the mobile communication device.

For easier use of the mobile communication device, a hands-free device having an earphone and a microphone mounted therein has come into wide use. Recently, a headset for short-range wireless communication, which has an earphone and a microphone mounted therein and can be worn on the user, has been provided together with a mobile communication device or has been sold separately.

However, since the conventional hands-free or headset is provided separately from the mobile communication device, the user is inconvenienced inconvenient in having to carry the separate headset. Furthermore, the user has to connect the hands-free or headset to the mobile communication device for use. Moreover, since the internal battery of a wireless headset has to be charged periodically, the user has to carry a separate battery charger of the wireless headset for a long period of time.

### SUMMARY OF THE INVENTION

It is, therefore, an object of the present invention to provide an easy-to-carry headset for a mobile communication device.

It is another object of the present invention to provide a mobile communication device having a removable headset that is easy to use.

It is further another object of the present invention to provide a headset for a mobile communication device, which is easy to recharge and thus can be carried for a long period of time.

To achieve the above and other objects, there is provided a mobile communication device having a removable headset. The mobile communication device includes a housing and the removable headset performs wireless communications with the housing. The headset is mounted in the housing to provide a receiving unit.

According to another aspect of the present invention, there is provided a mobile communication device including a first housing, and a second housing that is rotatably combined with the first housing by a hinge member. The mobile communication device includes a removable headset provided in the second housing. The headset provides a receiving unit for the mobile communication device when being mounted in the second housing and performs wireless communication with the mobile communication device when removed from the second housing.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view of a mobile communication device having a removable headset according to the present invention;

FIG. 2 is a perspective view showing a state in which the headset is removed from the mobile communication device of FIG. 1;

FIG. 3 is a perspective view showing a state in which a first housing and a second housing of the mobile communication device of FIG. 1 are opened;

FIG. 4 is a perspective view showing a state in which an earpiece unit of the headset of FIG. 1 slides; and

FIG. 5 is a perspective view of the headset of the mobile communication device of FIG. 1.

### DETAILED DESCRIPTION OF THE PREFERRED EMBODIMENT

A preferred embodiment of the present invention will now be described in detail with reference to the annexed drawings. In the following description, a detailed description of known functions and configurations incorporated herein has been omitted for conciseness.

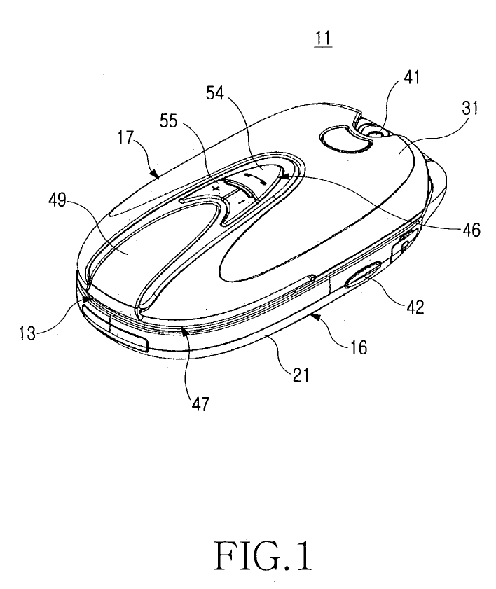

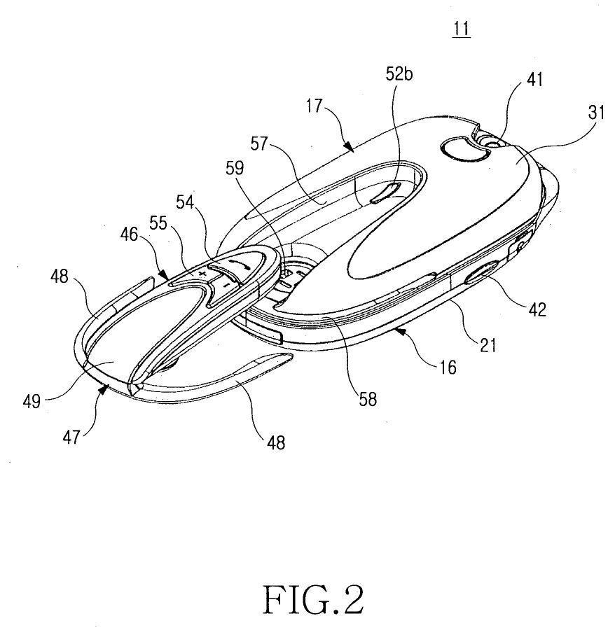

As shown in FIGS. 1 through 3, a mobile communication device 11 having a removable headset 13 includes a first housing 16 and a second housing 17 that are rotatably combined with each other by a hinge member 18. The headset 13 is mounted in the second housing 17 to provide the function of a receiving unit to the second housing 17 and is removed from the second housing 17 to provide the function of an ear-mic phone through short-range wireless communication with the first housing 16 or the second housing 17 of the mobile communication device 11.

Although a folder-type terminal including the first housing 16 and the second housing 17 is used as an example of the mobile communication device 11 in the following description, it can be easily understood by those skilled in the art that the headset 13 according to the present invention can be applied to various types of terminals such as a bar-type terminal, a sliding-type terminal, etc.

A keypad having a plurality of keys such as number/character input keys 23, a navigation key 26, a menu key 27, and a send/end key 28, and a transmitting unit 36 having a microphone embedded therein, are mounted on the inner side of the first housing 16. The transmitting unit 36 is disposed adjacent to the keypad and in a lower portion of the first housing 16. Although not shown in figures, a battery pack is mounted to the outer side of the first housing 16 to supply power to the mobile communication device 11. A display device 33 and a receiving unit 37 are mounted on the inner side of the second housing 17 facing the inner side of the first housing 16.

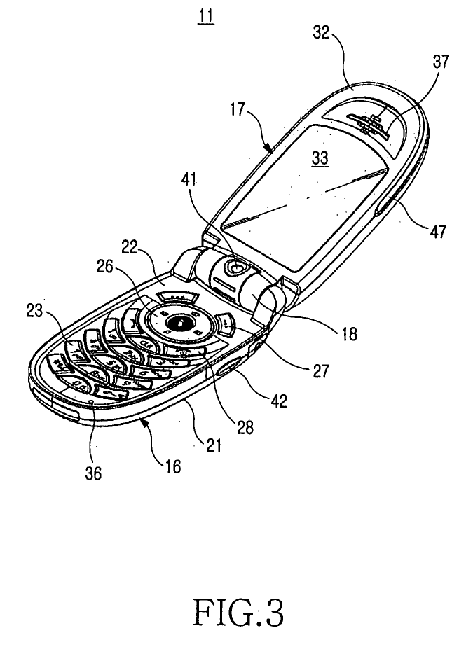

The hinge member 18 is provided between an upper portion of the first housing 16 and a lower portion of the second housing 17 to rotatably connect the second housing 17 to the first housing 16. The second housing 17 rotates relative to the hinge member 18, thereby rotating from a position folded to the first housing 16 as shown in FIG. 1 to a position unfolded from the first housing 16 as shown in FIG. 3. As the second housing 17 rotates while being combined with the first housing 16, the keypad, the transmitting unit 36, the display device 33, and the receiving unit 37 are opened or closed.

A camera lens 41 is mounted in a central portion of the hinge member 18 for photography in various directions while rotating relative to a rotation axis of the second housing 17. To operate the camera lens 41, a shutter key 42 may be provided on the outer circumferential face of the first housing 16.

The receiving unit 37 does not include a speaker phone and outputs sound generated from a speaker (51 of FIG. 5) provided in the headset 13 when the headset 13 is mounted in the second housing 17.

To mount the headset 13 in the second housing 17, a settling groove 57 is formed in the outer side of the second housing 17. The settling groove 57 extends from the outer circumferential face of one end of the second housing 17 towards the hinge member 18. A speaker hole 59 and power terminals 52b are installed in the inner side of the settling groove 57. The speaker hole 59 extends from the settling groove 57 to the inner side of the second housing 17, specifically the receiving unit 37. A clip groove 58 is formed in the second housing 17 to extend from the edge of the settling groove 57 along the outer circumference of the second housing 17.

The settling groove 57 receives and engages the headset 13 and the clip groove 58 secures the engagement of the headset 13.

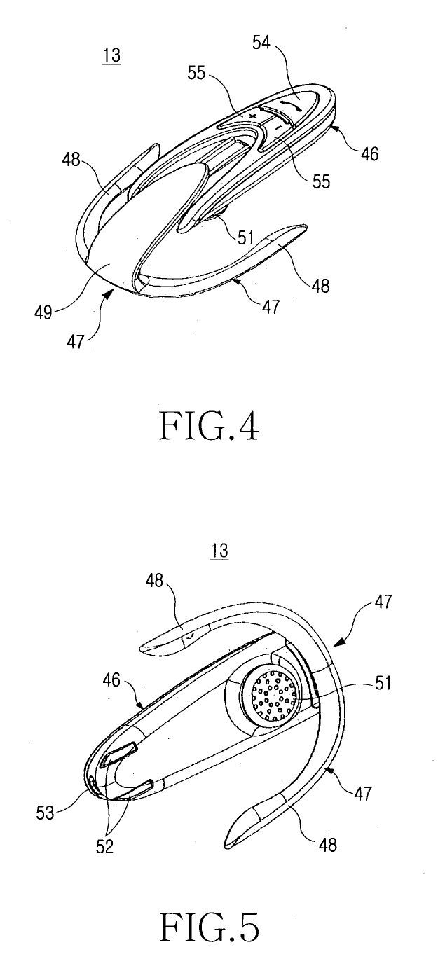

Referring to FIGS. 4 and 5, the headset 13 includes an earpiece unit 46 having a speaker 51 embedded therein and a mounting unit 47 engaged the second housing 17. The headset 13 performs wireless communication with the first housing 16 or the second housing 17 and has a battery therein to supply power for sound output and voice signal conversion.

The earpiece unit 46 includes the speaker 51 mounted in the inner side of the earpiece unit 46, charging terminals 52 mounted adjacent to one end of the earpiece unit 46, and a microphone 53 mounted in one end of the earpiece unit 46. When the headset 13 is received in the settling groove 57 of the second housing 17, the speaker 51 faces the speaker holes 59. Thus, a sound generated by the speaker 51 is output through the receiving unit 37 via the speaker holes 59.

When the headset 13 is received in the settling groove 57 of the second housing 17, the charging terminals 52 contact the power terminals 52b to draw power from a battery pack of the mobile communication device 11 to the headset 13. Thus, the headset 13 recharges its embedded battery.

The power terminals 52b and the charging terminals 52 may be used as signal transmission lines. In other words, when the headset 13 is received in the settling groove 57, a voice signal received through the mobile communication device 11 or sound signals of multimedia files reproduced by the mobile communication device 11 may be transmitted to the headset 13 through the power terminals 52b and the charging terminals 52. Thus, when the headset 13 is received in the settling groove 57, the speaker 51 can function as a receiving unit of the mobile communication device 11. It can be easily understood by those skilled in the art that a separate line for transmitting a sound signal to the headset 13 like the power terminals 52b and the charging terminals 52 may be installed.

At least one key is installed in the outer side of the earpiece unit 46. In an embodiment of the present invention, a pair of volume keys 55 for adjusting a volume output through the speaker 51 and a send/end key 54 are installed in the outer side of the earpiece unit 46. The keys 54 and 55 are used for voice communication when the headset 13 is removed from the settling groove 57 and are used for search, selection, reproduction, and termination with respect to multimedia files stored in the mobile communication device 11 when the headset 13 is received in the settling groove 57.

The earpiece unit 46 is slidably combined with the mounting unit 47. When the headset 13 is received in the settling groove 57, the earpiece 46 is in fixed state supported by the mounting unit 47.

The mounting unit 47 includes a support member 49 slidably combined with the outer side of the earpiece unit 46 and a pair of clip members 48 extending from one end of the support member 49. The clip members 48 are semicircular in shape to surround both sides by extending from both ends of the support member 49.

When the headset 13 is received in the settling groove 57, the clip members 48 are engaged in the clip groove 58 in such a manner that they surround the outer circumference of the second housing 17. Thus, the headset 13 is secured to the second housing 17.

At this time, as will be obvious to those skilled in the art, the inner sides of ends of the clip members 48 may protrude longer and both ends of the clip groove 58 may have shapes corresponding to the shapes of the ends of the clip members 48, thereby achieving a stronger removable structure.

As the earpiece unit 46 slides on the mounting unit 47, the speaker 51 moves towards or away from one end of the support member 49. FIG. 4 shows a state in which the earpiece unit 46 slides and thus the speaker 51 moves away from one end of the support member 49. FIG. 5 shows a state in which the speaker 51 moves towards one end of the support member 49.

With the sliding of the earpiece unit 46, the headset 13 may fit into a user's bodily shape. In other words, when the user wears the headset 13, the clip members 48 surround user's auricles and the earpiece unit 46 slides to position the speaker 51 to a user's ear hole. Thus, by slidably combining the earpiece unit 46 with the mounting unit 47, the position of the speaker 51 can be adjusted according to various shapes and sizes of users' ears.

Preferably, when the headset 13 is received in the settling groove 57, the outer side of the headset 13 is positioned on the same surface as the outer side of the second housing 17 and the outer sides of the clip members 48 are positioned on the same surface as the outer circumferential face of the second housing 17, so that the headset 13 can appear to be integrated into the second housing 17 when the headset 13 is received in the settling groove 57.

When the headset 13 is mounted in the second housing 17, the embedded battery of the headset 13 is recharged through the power terminal 52b and the charging terminals 52, and the headset 13 is provided with a sound signal from the mobile communication device 11 through an electrically formed signal line.

When the headset 13 is removed from the second housing 17, the headset 13 is provided with a sound signal from the mobile communication device 11 by short-range wireless communication with the first housing 16 or the second housing 17 of the mobile communication device 11 and converts user's voice input through the embedded microphone 53 into an electric signal to provide short-range wireless signal to the first housing 16 or the second housing 17 of the mobile communication device 11.

As described above, in a mobile communication device having a headset according to the present invention, the headset functions as a receiving unit for outputting partner's voice or sound signals when being mounted in a housing of the mobile communication device and functions as an ear-mic phone by performing short-range wireless communication with the mobile communication device when being removed from the mobile communication device, thereby becoming easy to use. Moreover, the headset is mounted in the housing of the mobile communication device, thereby allowing the user to easily carry the headset. Furthermore, since the headset is charged while being mounted in the housing of the mobile communication device, the user does not need to carry a separate charger.

While the invention has been shown and described with reference to a certain preferred embodiment thereof, it will be understood by those skilled in the art that various changes in form and details may be made therein without departing from the spirit and scope of the invention. For example, the mounting unit 47 and the earpiece unit 46 of the headset 13 can slide in an embodiment of the present invention, but the mounting unit 47 and the earpiece unit 46 may be integrated into one body and a position of the inner side of the headset 13 in which the speaker 51 is installed may be adjusted. In other words, distances between the clip members 48 and the speaker 51 are adjusted in order to allow the user to easily use the headset 13 according to the shapes of the ears of the user.

What is claimed is:

1. A mobile communication device comprising:
a housing; and
a removable headset performing wireless communication with the housing when the removable headset is removed from the housing,
wherein the headset provides a receiving unit for the mobile communication device when the headset is mounted in the housing.

2. The mobile communication device of claim 1, wherein the headset comprises:
an earpiece unit having a speaker phone mounted therein; and
a mounting unit combined with the earpiece unit and removable from the housing.

3. The mobile communication device of claim 2, wherein the mounting unit comprises:
a support member slidably combined with the earpiece unit; and
a pair of clip members extending from one end of the support member,
wherein the clip members are mounted in such a way to surround a portion of the outer circumferential face of the housing.

4. The mobile communication device of claim 3, wherein the clip members are semicircular in shape to surround both sides by extending from both ends of the support member.

5. The mobile communication device of claim 3, further comprising a clip groove formed along an outer circumference of the housing, wherein the clip members are engaged in the clip groove when the headset is mounted in the housing.

6. The mobile communication device of claim 5, wherein the outer sides of the clip members are positioned in the same surface as the outer circumferential face of the housing when the clip members are engaged in the clip groove.

7. The mobile communication device of claim 1, further comprising charging terminals provided adjacent to one end of the headset, wherein the headset is electrically connected to the housing through the charging terminals when the headset is mounted in the housing.

8. The mobile communication device of claim 1, further comprising:
a settling groove formed in one side of the housing; and
a speaker hole extending from the settling groove to an other side of the housing,
wherein the headset outputs a sound through the speaker hole when being mounted in the settling groove.

9. The mobile communication device of claim 8, further comprising:
charging terminals provided adjacent to one end of the headset; and
power terminals provided in the settling groove,
wherein the charging terminals contact the power terminals when the headset is mounted in the settling groove.

10. The mobile communication device of claim 8, wherein the outer side of the headset is positioned in the same surface as the outer side of the housing when the headset is mounted in the settling groove.

11. The mobile communication device of claim 1, further comprising at least one key provided in the outer side of the headset.

12. The mobile communication device of claim 11, wherein the key provided in the outer side of the headset is used to adjust a volume output through the headset.

13. The mobile communication device of claim 11, wherein the key provided in the outer side of the headset is used to initiate and/or terminate wireless communication between the headset and the housing.

14. The mobile communication device of claim 11, wherein the key provided in the outer side of the headset comprises:
a key for adjusting a volume output through the headset; and
a key for initiating and/or terminating wireless communication between the headset and the housing.

15. The mobile communication device of claim 1, further comprising a microphone provided in one end of the headset.

16. A mobile communication device comprising:
a first housing;
a second housing rotatably combined with the first housing by a hinge member; and
a removable headset provided in the second housing,
wherein the headset provides a receiving unit for the mobile communication device when being mounted in the second housing and performs wireless communication with the mobile communication device when being removed from the second housing.

17. The mobile communication device of claim 16, further comprising:
a settling groove formed in an outer side of the second housing; and
a speaker hole extending to an inner side of the second housing,
wherein when the headset is mounted in the settling groove, the headset can output a sound through the speaker hole.

18. The mobile communication device of claim 17, wherein the settling groove extends from an outer circumferential face of one end of the second housing towards the hinge member, and an outer side of the headset is positioned in a same surface as the outer side of the second housing when the headset is mounted in the settling groove.

19. The mobile communication device of claim 17, further comprising:
a clip groove extending from an edge of the settling groove along an outer circumference of the second housing; and
a pair of clip members extending in a semicircular shape from one end of the headset in a direction away from each other,
wherein the clip members are engaged in the clip groove when the headset is mounted in the settling groove.

20. The mobile communication device of claim 17, further comprising:
power terminals provided in the settling groove; and
charging terminals provided in the headset,
wherein the charging terminals contact the power terminals when the headset is mounted in the settling groove.

21. The mobile communication device of claim 16, wherein the headset comprises:
a support member;
a mounting unit including clip members extending from one end of the support member to surround one end and both sides of the support member; and
an earpiece unit slidably combined to the support member and having a speaker phone mounted therein.

22. The mobile communication device of claim 21, further comprising:
charging terminals provided adjacent to one end of the earpiece unit; and
a microphone provided in one end of the earpiece unit.

23. The mobile communication device of claim 21, further comprising at least one key provided in an outer side of the earpiece unit.

24. The mobile communication device of claim 23, wherein the key provided in the outer side of the headset comprises:
a key for adjusting a volume output through the headset; and
a key for initiating and/or terminating wireless communication between the headset and the second housing when the headset is removed from the second housing.

25. The mobile communication device of claim 16, further comprising a camera lens mounted in the hinge member.

26. The mobile communication device of claim 25, further comprising a shutter key provided in an outer circumferential face of the first housing to operate the camera lens.

27. The mobile communication device of claim 16, further comprising:
a keypad provided in the first housing; and
a transmitting unit provided adjacent to the keypad and having a microphone embedded therein,
wherein the keypad and the transmitting unit are opened or closed by rotation of the second housing.

28. The mobile communication device of claim 16, further comprising a display device provided in the second housing, wherein the receiving unit is mounted adjacent to the display device.
